(19) United States
(12) Patent Application Publication
(10) Pub. No.: US 2004/0125047 A1
(43) Pub. Date: Jul. 1, 2004

(54) Headgear system with display

(75) Inventors: Mark H. Crane, San Jose, CA (US); Michael J. Presz, Felton, CA (US); Lawrence M. Cuprys, Felton, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Kopin Corporation, Taunton, MA

(21) Appl. No.: 10/647,059

(22) Filed: Aug. 22, 2003

Related U.S. Application Data
(60) Provisional application No. 60/405,788, filed on Aug. 23, 2002.

(51) Int. Cl. G09G 5/00

(52) U.S. Cl. 345/8

(57) ABSTRACT

A headgear system which includes headgear with an upper headgear portion for being worn on a user's head. A lower headgear portion extends forwardly relative to a lower front portion of the user's head and below the user's eyes. A display assembly is mounted to the lower headgear portion for being located below at least one of the user's eyes so as not to obstruct the user's vision. The display assembly has a display that is visible when the at least one of the user's eyes looks downwardly. The display assembly is configured to be adjustable by the user while the headgear system is worn by the user for changing the orientation of the display for suitable viewing.

### RELATED APPLICATION

This application claims the benefit of U.S. Provisional Application No. 60/405,788, filed Aug. 23, 2002. The entire teachings of the above application are incorporated herein by reference.

### BACKGROUND

Helmet display systems often include a display which is positioned directly in front of one of the user's eyes for displaying images and/or information. The display is typically mounted to the helmet at a location above or to the side of the eye. A drawback with such an approach is that the user's field of vision can be reduced by the display. Other helmet display systems display images and/or information on a visor or shield positioned in front of the user's face. However, this approach requires the visor to be in place to view the displayed images and/or information. Depending upon the contours of the visor, vision can also be distorted through certain areas of the visor.

### SUMMARY

The present invention provides a headgear system with a display which minimizes the obstructions to a user's vision, and distortion.

The present invention includes a headgear system having headgear with an upper headgear portion for being worn on a user's head. A lower headgear portion extends forwardly relative to a lower front portion of the user's head and below the user's eyes. A display assembly is mounted to the lower headgear portion for being located below at least one of the user's eyes so as not to obstruct the user's vision. The display assembly has a display that is visible when the at least one of the user's eyes looks downwardly. The display assembly is configured to be adjustable by the user while the headgear system is worn by the user for changing the orientation of the display for suitable viewing.

In preferred embodiments, the headgear is a helmet and the lower headgear portion is a chin or face bar of the helmet. The display assembly includes at least one rotatable joint having frictional resistance so that the joint remains in a particular orientation until moved by the user. The display is sized for viewing by one of the user's eyes when looking downwardly. The display displays images which are focused at about optical infinity so that the user does not need to refocus his/her eyes when viewing the images.

In one embodiment, the display assembly has a rotatable horizontal axis for allowing the display to be tilted upwardly and downwardly, and a rotatable vertical axis for allowing the display to be tilted side to side, relative to the user's head. The display assembly includes a base for mounting to the face bar of the helmet. The base has a circular recess that is connected to an entrance slot. A rotatable member having a generally circular portion has a snap fit into the circular recess of the base through the entrance slot. The rotatable member is rotatable within the circular recess about the vertical axis. Two side members extend from the rotatable member between which the display is rotatably mounted along the horizontal axis. The display assembly is mounted to the face bar of the helmet for being below a first eye of the user. A second base is mounted to the face bar for being below a second eye of the user to allow the user to select the position of at least one display by snap fitting an associated rotatable member into the desired base. A display can be positioned under either the first or the second eye. If desired, a display can be positioned in each base under each eye.

The present invention also provides a headgear system including headgear for being worn by a user. A display assembly having a display is mounted to the headgear. The display assembly is configured to be adjustable by the user while the headgear system is worn by the user for changing the orientation of the display. The display assembly has a rotatable horizontal axis for allowing the display to be tilted upwardly and downwardly, and a rotatable vertical axis for allowing the display to be tilted side to side, relative to the user's head.

In preferred embodiments, the display assembly includes a base for mounting to the headgear. The base has a circular recess that is connected to an entrance slot. A rotatable member having a generally circular portion has a snap fit into the circular recess of the base through the entrance slot. The rotatable member is rotatable within the circular recess about the vertical axis. Two side members extend from the rotatable member with the display being rotatably mounted between the side members along the horizontal axis.

The present invention additionally provides a method of displaying information to a user including providing the user with headgear having an upper headgear portion for being worn on the user's head. A lower headgear portion extends from the upper headgear portion for extending forwardly relative to a lower front portion of the user's head and below the user's eyes. A display assembly is mounted to the lower headgear portion below at least one of the user's eyes so as not to obstruct the user's vision. The display assembly has a display for displaying information that is visible when said at least one of the user's eyes looks downwardly. The display assembly is configured to be adjustable by the user while the headgear system is worn by the user for changing the orientation of the display for suitable viewing.

The present invention further provides a method of displaying information to a user including providing the user with headgear for being worn on the user's head. A display assembly having a display for displaying information is mounted to the headgear. The display assembly is configured to be adjustable by the user while the headgear is worn by the user for changing the orientation of the display for suitable viewing. The display assembly has a rotatable horizontal axis for allowing the display to be tilted upwardly and downwardly, and a rotatable vertical axis for allowing the display to be tilted side to side relative to the user's head.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a front perspective view of an embodiment of a display assembly in the present invention.

FIG. 2 is a bottom perspective view of the display assembly of FIG. 1.

FIG. 3 is an exploded view of the display assembly of FIG. 1.

FIG. 4 is a bottom perspective view of the interior of an embodiment of a helmet system in the present invention with a display assembly mounted to the face bar of the helmet at the right and an alternative left base mount also mounted to the face bar.

FIG. 5 is a front perspective view of the helmet system of FIG. 4 worn by a user.

### DETAILED DESCRIPTION

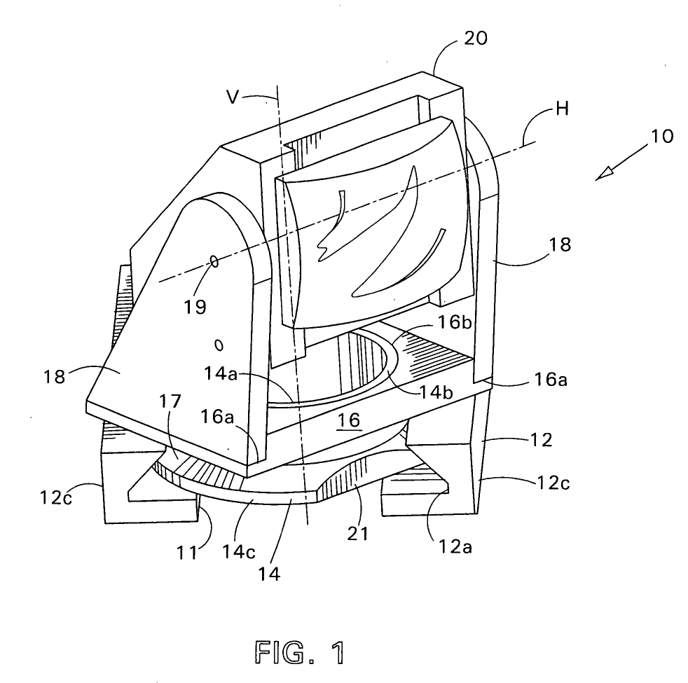

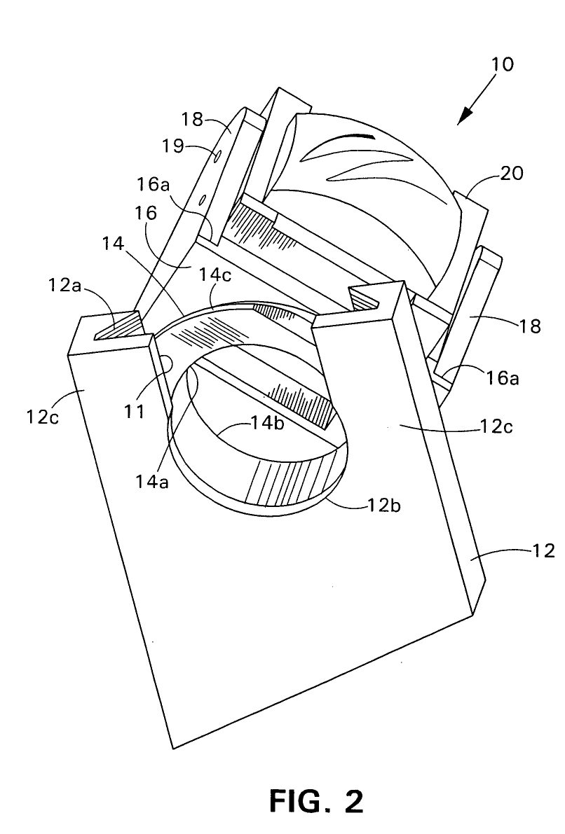

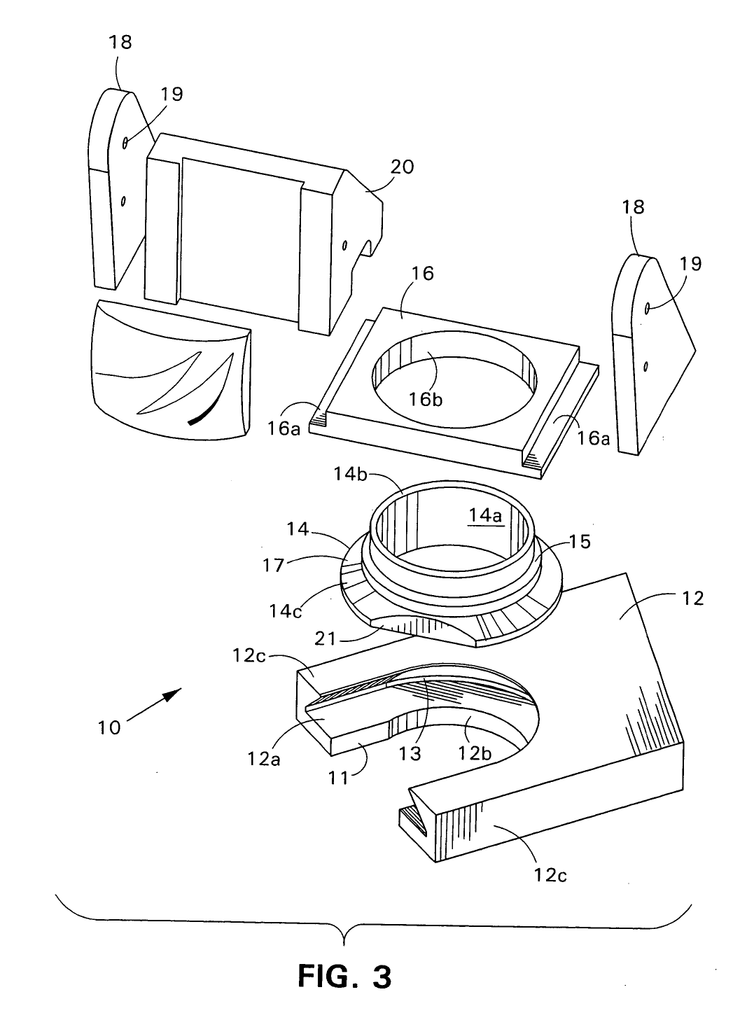

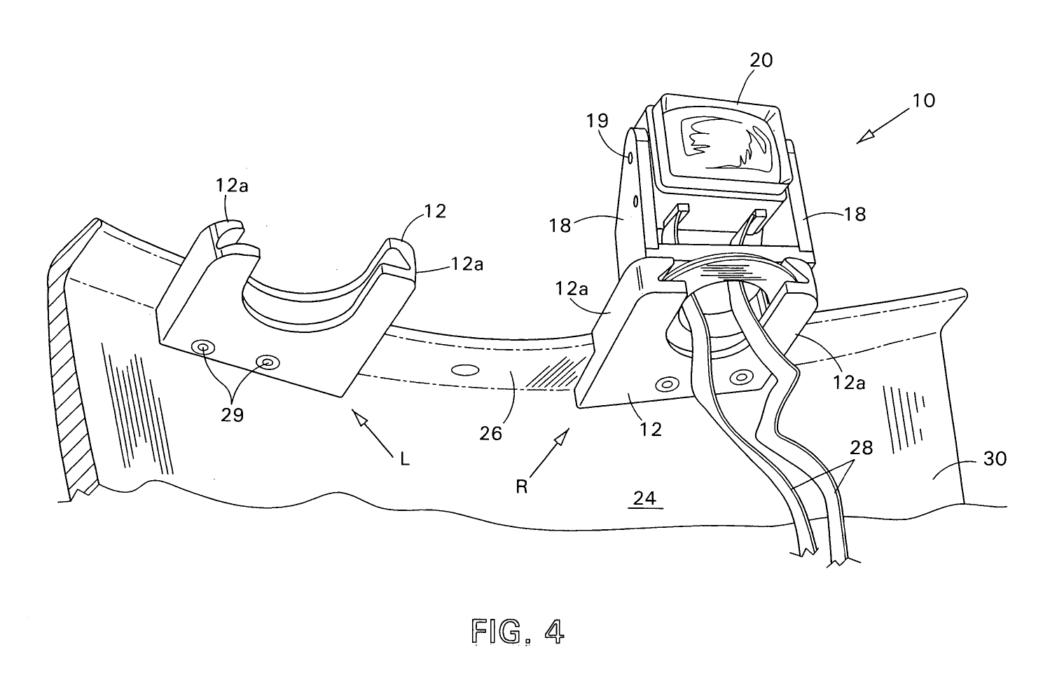

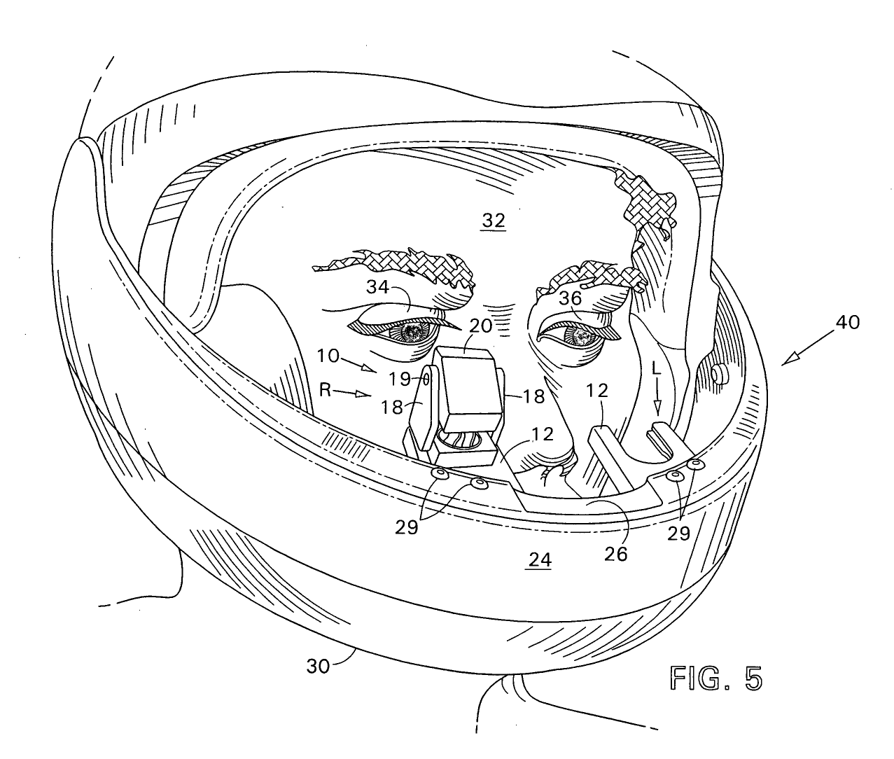

Referring to FIGS. 1-3, display assembly 10 is one embodiment of a display assembly in the present invention and can be mounted to a headgear such as in a helmet 30 (FIGS. 4 and 5) as part of a headgear or helmet system 40 for providing the user 32 with information and/or images. For example, in motorcycle applications, or in auto racing applications, displayed information can include speed, revolutions per minute (RPM), oil pressure, time, basic GPS data, pager indicia, etc. Display assembly 10 includes a display module 20 having viewing optics for displaying the information and/or images. The display 20 is rotatably mounted by a horizontal first joint about a horizontal first axis H (FIG. 1) between two yoke or side members 18 about pivot points 19 to allow the display 20 to be pivoted upwardly and downwardly relative to the user's 32 face. Display 20 is rotatably mounted to side members 18 in a frictional manner where display 20 will stay in a particular orientation until moved by user 32. Enough frictional drag is provided to allow adjustment yet survive shock and vibration.

The side members 18 are in turn mounted within recesses 16a on opposite sides of a generally planar bottom plate 16. The bottom plate 16 has a central opening 16b which engages the neck 14b and shoulder 15 of a generally circular rotatable member or swivel ring 14, and is secured thereto. The swivel ring 14 has an outwardly extending generally circular flange 14c with an angled top surface 17 and can have a flat 21. The swivel ring 14 is snap fitted and captured within a generally planar base 12.

The base 12 has a circular recess or hole 12b therethrough which is connected to an entrance slot 11 extending from one edge with two base legs 12c being on opposite sides thereof. A dove tail groove 12a, generally having the cross sectional shape of the flange 14c with a flat bottom surface and an angled top surface, extends through the base legs 12c and into a circular annular recess 13 within base 12. Circular recess 13 concentrically surrounds recess or hole 12b. The circular recess 13 has the same shape as flange 14c and is sized to allow frictional rotation of the flange 14c therein. In addition, the outer diameter of shoulder 15 and hole 12b are also sized to provide frictional rotation of the shoulder 15 relative to hole 12b. The combination of these two regions forms a separate vertical second joint which provides swivel ring 14 with frictional rotation about a vertical second axis V (FIG. 1) so that the display 20 can be pivoted side to side relative to the user's 32 face. As a result, swivel ring 14 is rotatably mounted to base 12 in a frictional manner where swivel ring 14 will stay in a particular orientation until moved by user 32. As with axis H, the proper amount of frictional drag is provided. The angles of the groove 12a and interference dimensions of the contacting regions create the appropriate amount of drag required. The slot 11 is dimensioned to be narrower than the outer diameter of shoulder 15 to provide swivel ring 14 with a snap fit into base 12 where legs 12c deflect slightly outward when shoulder 15 passes through slot 11. Alternatively, slot 11 can include protrusions to provide the snap fit. Hole 12b in base 12 and hole 14a in swivel ring 14 allow access and passage of cables and wires 28 therethrough to display 20 (FIG. 4).

Referring to FIGS. 4 and 5, in use, the base 12 of display assembly 10 can be mounted to the upper edge 26 of the chin or face bar 24 of a helmet 30, typically, by fasteners 29. The display assembly 10 is positioned on face bar 24 to be below one of the user's 32 eyes, for example, position R under the right eye 34, as shown. A second base 12 can be mounted to the face bar 24 to be below the other eye, for example, position L under the left eye 36, as shown. This allows the display 20 to be moved under either eye according to one or more user's 32 preference, for example, the dominant eye. The snap fit feature of the swivel ring 14 with base 12 allows for easy removal and insertion between the two bases 12 so as to be right or left eye compatible. In addition, adjustment of the position or orientation of display 20 is desired because each user 32 can have different head and face dimensions, for example, the horizontal or lateral distance between the eyes 34 and 36 can differ as well as the vertical distance between the eyes 34 and 36, and the face bar 24. Furthermore, even for the same user 32, the position of the face bar 24 relative to the eyes 34 and 36 can change with helmet movement, for example, the helmet 30 can sit differently on the user's 32 head when leaning forward, in comparison when sitting upright. The display assembly 10 can be adjusted by the user 32 even when wearing gloves while the helmet 30 is being worn and during driving to position display 20 in a location and orientation suitable for viewing depending upon eye location.

Tilting the display 20 up and down relative to the user's 32 head about the horizontal axis H typically adjusts for the vertical distance between the eyes 34 and 36, and the face bar 24 or in other words, the vertical position of eye 34 or 36. Pivoting the display 20 side to side relative to the user's 32 head about vertical axis V typically adjusts for different lateral distances between different users' 32 eyes 34 and 36, interpupilary distance (IPD), to adjust to the horizontal or lateral position of a particular eye. These adjustments change the position of display 20 about two axes of rotation which tilts the display into an orientation suitable for viewing for a particular location of the eye 34 or 36. The terms horizontal joint and axis H, vertical joint and axis V, upwardly, downwardly, and side to side, are used to describe the relationship of the display assembly 10 relative to the normal upright vertical orientation of a user's 32 head. It is understood that the user's 32 head can be orientated at angles, or horizontally which would also change the orientation of the display assembly 10 accordingly. As a result, the two rotational axes H and V can also be described as being orthogonal relative to each other with axis V extending generally in a longitudinal direction relative to the user's 32 head, and axis H extending generally in a lateral direction in front of the user's 32 face, for providing tilt and rotation of display 20.

Typically, the display 20 is positioned below the users 32 eye, such as the right eye as shown 34, so that for normal distance vision, the line of sight of the right eye 34 passes over the display 20. Such a position does not significantly obscure the users 32 field of vision of the real world scene. This also provides sufficient space to allow use by users 32 who wear glasses. In order to view the information and/or images on display 20 with right eye 34, the user 32 merely glances downward. The information and/or images displayed on display 20 are focused in a manner to achieve or approximate optical infinity so that the user 32 does not need to refocus eye 34 to view display 20, which saves time. This can be advantageous for motorcycle or automotive racing situations because the user's 32 attention can remain on the road. Time spent refocusing one's eyes can cause a racer to lose an opportunity to make a move, or can be dangerous. If a driver has to shift his/her eyes to a conventional instrument panel in a vehicle, the eyes must refocus to look down and then again to look up at the road.

In the embodiment of the display assembly 10 depicted in FIGS. 1-3, the shape and configuration of the dove tail groove 12a and the swivel ring 14 with the flange 14c is a design that allows the display assembly 10 to be made small if desired, which allows display assembly 10 to be mounted within a helmet 30 and can also fit behind a face shield. The display assembly 10 can also be retrofitted into existing helmets. In one embodiment, the entire display assembly 10 can be made about 1.35 inches tall, with the base 12 being about 1.25 inches long by 1.2 inches wide and 0.250+/−0.005 inches thick. In addition, swivel ring 14 can have a flange 14c with an outer diameter of 0.938+0.000/−0.001 inches and a shoulder 15 with an outer diameter of 0.783+0.000/−0.001 inches. The flange 14c, the dove tail groove 12a and circular recess 13 in base 12 have a top surface that is angled at about 52°. The circular recess 13 and the dove tail groove 12a have a diameter and width, respectively, of 0.938+0.001/−0.000 inches. Slot 11 in base 12 is 0.750+0.000/−0.001 inches and hole 12b is 0.783+0.001/−0.000 inches. Such dimensions can provide suitable frictional drag and capture characteristics, but it is understood that other suitable dimensions are possible depending upon the situation at hand. The tolerances on the dimensions allow for interchangeability of parts. The components of display assembly 10 can be made of materials such as plastics, suitable metals, or combinations thereof. Typically, the parts of display assembly 10 are light weight and solid for crash safety. The helmet's 30 crash worthiness is not compromised. Display assembly 10 can have a matte finish for low glare where reflections of ambient light are minimized.

The display 20 depicted in the figures is manufactured by Kopin Corporation, but it is understood that other suitable displays can be employed. The display 20 can be either monochrome or full color. The brightness of display 20 can be adjusted for readability purposes, for example, in sunlight. Typically, display 20 has about a 10° to 30° field of view and infinite adjustment resolution. The optics of display 20 can be folded or in-line. Power to display 20 can be provided by cable or internal battery and signals to display 20 can be provided by wired or wireless interface. Miniature electronics can be provided in the face bar 24 that interfaces to a wide range of driver platforms.

While this invention has been particularly shown and described with references to preferred embodiments thereof, it will be understood by those skilled in the art that various changes in form and details may be made therein without departing from the scope of the invention encompassed by the appended claims.

For example, although particular embodiments have been shown and described, it is understood that rotation of display 20 about two axes can be achieved by other suitable means in addition to that shown, for example, by a ball joint. A ball joint can provide rotation about vertical and horizontal axes in one joint. Also dove tail groove 12a and circular recess 13 can be omitted with swivel ring 14 having flanges that extend above and below base 12 for capturing the base 12 therebetween. Although the headgear system in the present invention has been shown to include a helmet 30, it is understood that the headgear does not have to be a helmet and instead can be or include a headband, mask, eye wear, etc. In addition, the display assembly 10 can also be attached at other suitable locations of the headgear, which includes attachment to the headgear above the eyes, such as at the forehead, or to the side of the eyes. Furthermore, if desired, the display assembly 10 can be employed for positioning display 20 directly in front of an eye. Also, although examples of vehicle related information and/or images for display have been described above, it is also contemplated that computer and TV/video capabilities can also be displayed. The present invention headgear system can also be used in sports, such as for signaling plays to a quarterback, pitch selection to a catcher, etc. If desired, the display 20 can be made larger so that information and/or images can be viewed by both eyes instead of by just one. Alternatively, two displays 20 can be employed, one for each eye. For example, referring to FIGS. 4 and 5, a display 20 can be mounted in each base 12 at positions R and L. Such a configuration can provide binocular capabilities. If desired, swivel ring 14 does not have to be snap fitted into base 12 but instead can be rotatably mounted by other conventional means.

What is claimed is:

1. A headgear system comprising:
headgear with an upper headgear portion for being worn on a user's head and a lower headgear portion extending from the upper headgear portion for extending forwardly relative to a lower front portion of the user's head and below the user's eyes; and
a display assembly mounted to the lower headgear portion for being located below at least one of the user's eyes so as not to obstruct the user's vision, the display assembly having a display that is visible when said at least one of the user's eyes looks downwardly, the display assembly being configured to be adjustable by the user while the headgear system is worn by the user for changing the orientation of the display.

2. The headgear system of claim 1 in which the headgear is a helmet, and the lower headgear portion is a face bar.

3. The headgear system of claim 2 in which the display assembly includes at least one rotatable joint having frictional resistance so that the joint remains in a particular orientation until moved by the user.

4. The headgear of claim 3 in which the display is sized for viewing by one of the user's eyes when said one of the user's eyes looks downwardly.

5. The headgear of claim 4 in which the display displays images which are focused at about optical infinity.

6. The headgear system of claim 3 in which the display assembly has a rotatable horizontal axis for allowing the display to be tilted upwardly and downwardly, and a rotatable vertical axis for allowing the display to be tilted side to side, relative to the user's head.

7. The headgear system of claim 6 in which the display assembly comprises:
a base for mounting to the face bar of the helmet, the base having a circular recess that is connected to an entrance slot;
a rotatable member having a generally circular portion that has a snap fit into the circular recess of the base through the entrance slot, the rotatable member being rotatable within the circular recess about the vertical axis; and
two side members extending from the rotatable member, the display being rotatably mounted between the side members along the horizontal axis.

8. The headgear system of claim 7 in which the display assembly is mounted to the face bar of the helmet for being below a first eye of the user, the headgear system further comprising a second base mounted to the face bar of the helmet for being below a second eye of the user to allow the user to select the position of at least one display by snap fitting an associated rotatable member into the desired base.

9. A headgear system comprising:
headgear for being worn by a user; and
a display assembly having a display mounted to the headgear, the display assembly being configured to be adjustable by the user while the headgear system is worn by the user for changing the orientation of the display, the display assembly having a rotatable horizontal axis for allowing the display to be tilted upwardly and downwardly, and a rotatable vertical axis for allowing the display to be tilted side to side, relative to the user's head.

10. The headgear system of claim 9 in which the display assembly comprises:
a base for mounting to the headgear, the base having a circular recess that is connected to an entrance slot;
a rotatable member having a generally circular portion that has a snap fit into the circular recess of the base through the entrance slot, the rotatable member being rotatable within the circular recess about the vertical axis; and
two side members extending from the rotatable member, the display being rotatably mounted between the side members along the horizontal axis.

11. A method of displaying information to a user comprising:
providing the user with headgear having an upper headgear portion for being worn on the user's head and a lower headgear portion extending from the upper headgear portion for extending forwardly relative to a lower front portion of the user's head and below the user's eyes; and
mounting a display assembly to the lower headgear portion below at least one of the user's eyes so as not to obstruct the user's vision, the display assembly having a display for displaying information that is visible when said at least one of the user's eyes looks downwardly, the display assembly being configured to be adjustable by the user while the headgear is worn by the user for changing the orientation of the display for suitable viewing.

12. The method of claim 11 further comprising providing the user with a headgear that is a helmet, and the lower headgear portion being a face bar.

13. The method of claim 12 further comprising providing the display assembly with at least one rotatable joint having frictional resistance so that the joint remains in a particular orientation until moved by the user.

14. The method of claim 13 further comprising sizing the display for viewing by one of the user's eyes when said one of the user's eyes looks downwardly.

15. The method of claim 14 further comprising displaying images on the display which are focused at about optical infinity.

16. The method of claim 13 further comprising providing the display assembly with a rotatable horizontal axis for allowing the display to be tilted upwardly and downwardly, and a rotatable vertical axis for allowing the display to be tilted side to side, relative to the user's head for adjusting to different users and helmet positions.

17. The method of claim 16 further comprising:
providing the display assembly with a base for mounting to the face bar of the helmet, the base having a circular recess that is connected to an entrance slot, a rotatable member having a generally circular portion being snap fit into the circular recess of the base through the entrance slot, the rotatable member being rotatable within the circular recess about the vertical axis, the display being rotatably mounted between two side members extending from the rotatable member along the horizontal axis.

18. The method of claim 17 further comprising:
positioning the display assembly to the face bar of the helmet below a first eye of the user; and
providing a second base mounted to the face bar of the helmet below a second eye of the user to allow the user to select the position of at least one display by snap fitting an associated rotatable member into the desired base.

19. A method of displaying information to a user comprising:
providing the user with headgear for being worn on the user's head; and
mounting a display assembly having a display for displaying information to the headgear, the display assembly being configured to be adjustable by the user while the headgear is worn by the user for changing the orientation of the display for suitable viewing, the display assembly having a rotatable horizontal axis for allowing the display to be tilted upwardly and downwardly, and a rotatable vertical axis for allowing the display to be tilted side to side, relative to the user's head.

20. The method of claim 19 further comprising providing the display assembly with a base for mounting to the headgear, the base having a circular recess that is connected to an entrance slot, a rotatable member having a generally circular portion being snap fit into the circular recess of the base through the entrance slot, the rotatable member being rotatable within the circular recess about the vertical axis, the display being rotatably mounted between two side members extending from the rotatable member along the horizontal axis.
